(19) United States
(12) Patent Application Publication
(10) Pub. No.: US 2015/0348706 A1
(43) Pub. Date: Dec. 3, 2015

(54) COIL ELEMENT PRODUCTION METHOD

(71) Applicant: LEAP Co., Ltd., Kanagawa (JP)

(72) Inventors: Takashi SANO, Kanagawa (JP); Tokinori TERADA, Kanagawa (JP)

(73) Assignee: Leap Co. Ltd.

(21) Appl. No.: 14/438,916

(22) PCT Filed: Oct. 30, 2012
(86) PCT No.: PCT/JP2012/006959

§ 371 Date: Apr. 28, 2015

(51) Int. Cl. H01F 41/04

(52) U.S. Cl. CPC H01F 41/041

(57) ABSTRACT

Provided is a method for manufacturing a coil element, capable of manufacturing a coil element using a resin mold and without performing releasing and transferring, and capable of thinning the coil element. A method for manufacturing a coil element using a resin mold that is soluble in organic solvent, includes, preparing a resin mold, on a surface of which an inverted coil element pattern is engraved, forming a metal seed film on the surface of the resin mold, removing the metal seed film in an area where the inverted coil element pattern is not formed, forming a center conductive film so as to fill an area where the inverted coil element pattern is engraved by first electroplating while using the metal seed film as a base, and dissolving the resin mold to take out the center conductive film.

### CROSS-REFERENCE TO RELATED APPLICATIONS

This application is the National Stage of International Application No. PCT/JP2012/006959 having International filing date 30 Oct. 2012, which designated the United States of America, and which International Application was published under PCT Article 21 (s) as WO Publication 2014/068612 A1 the disclosures of which are incorporated herein by reference in their entireties.

### BACKGROUND

The presently disclosed embodiment relates to methods for manufacturing coil elements, and particularly relates to a method for manufacturing a coil element using a resin mold that is soluble in organic solvent.

With the recent development of mobile devices such as smartphones and table terminals equipped with multifunctions, there is a growing need for coil components (inductors) that are compact in size and capable of operating with high rated current.

A known method for manufacturing such a coil component is to use a metal mold for transferring. In this method, a metal mold is used, on a surface of which an inverted coil element pattern is engraved, and a coil element is formed in this metal mold by electroplating, followed by releasing of the coil element from this metal mold, which is then transferred to a component substrate.

Another known method that does not use a metal mold is to form a plated resist pattern on a substrate, followed by formation of a coil element pattern by electroplating, from which the plated resist pattern is removed, and the resultant is transferred to a sheet-form magnetic material layer.

Both of these methods have a problem of easy falling or dropping of a conductive pattern during the releasing or the transferring of the coil element because the coil element is formed by transferring.

Meanwhile Japanese Patent Application Laid-Open No. 2005-191408 describes a method of using a resin mold instead of a metal mold. In this method, a coil element formed in this resin mold is not transferred, but is directly used.

Japanese Patent Application Laid-Open No. 2006-332147 describes the manufacturing of a coil conductor by forming a coil conductor made up of a conductive main section and a conductive cap section embedded in a photosensitive insulating resin section on a metal substrate, followed by releasing of this metal board.

### SUMMARY

Since both of the methods for manufacturing a coil component described in Japanese Patent Application Laid-Open No. 2005-191408 and Japanese Patent Application Laid-Open No. 2006-332147 as stated above do not release or transfer a coil element pattern, they do not cause the problem of falling or dropping of a conductive pattern.

The method described in Japanese Patent Application Laid-Open No. 2005-191408, however, has the problem that a single coil component is thick because a resin mold is directly used after the formation of a coil component, and especially when a laminated coil component is to be manufactured, the volume of the component will be large.

The method described in Japanese Patent Application Laid-Open No. 2006-332147 also has the same problem that a single coil component is thick because a conductive main section embedded in a photosensitive insulating resin section is formed at an inner layer part of an insulating resin section.

In order to solve these problems, the presently disclosed embodiment aims to provide a method for manufacturing a coil element, capable of manufacturing a coil element using a resin mold and without performing releasing and transferring, and capable of thinning the coil element.

The aforementioned object can be achieved by the following presently disclosed embodiment.

The first aspect of the presently disclosed embodiment relates to a method for manufacturing a coil element using a resin mold that is soluble in organic solvent, and the method includes: preparing a resin mold, on a surface of which an inverted coil element pattern is engraved; forming a metal seed film on the surface of the resin mold; removing the metal seed film in an area where the inverted coil element pattern is not formed; forming a center conductive film so as to fill an area where the inverted coil element pattern is engraved by first electroplating while using the metal seed film as a base; and dissolving the resin mold to take out the center conductive film.

The second aspect of the presently disclosed embodiment relates to a method for manufacturing a coil element using a resin mold that is soluble in organic solvent, and the method includes: preparing a resin mold, on a surface of which an inverted coil element pattern is engraved; forming a metal seed film on the surface of the resin mold; forming an insulating film in an area where the inverted coil element pattern is not formed; forming a center conductive film that remains in the insulating film so as to fill an area where the inverted coil element pattern is engraved by first electroplating while using the metal seed film as a base; removing the insulating film; dissolving the resin mold to take out the center conductive film and the metal seed film; and removing the metal seed film.

The third aspect of the presently disclosed embodiment relates to a method for manufacturing a coil element using a resin mold that is soluble in organic solvent, and the method includes: preparing a resin mold on a metal substrate, the resin mold having an inverted coil element pattern engraved therein so that the inverted coil element pattern has a bottom face that does not reach the metal substrate; etching so that the bottom face of the inverted coil element pattern reaches the metal substrate so as to remove resin below the bottom face; forming a center conductive film that remains in the resin mold so as to fill an area where the inverted coil element pattern is engraved by first electroplating while using the metal substrate as a base; dissolving the resin mold; and releasing the center conductive film from the metal substrate for taking out.

The fourth aspect of the presently disclosed embodiment relates to a method for manufacturing a coil element using a resin mold that is soluble in organic solvent, and the method includes: preparing a second mold by placing a first mold on a metal substrate, the first mold having an inverted coil element pattern engraved therein so as to come into intimate contact with the metal substrate; pouring resin in the second mold to fill the first mold with the resin, followed by curing of the resin; removing the first mold so as to manufacture a resin mold, in which an inverted coil element pattern is formed; forming a center conductive film so as to fill an area where the inverted coil element pattern is engraved by first electroplating while using the metal substrate as a base; dissolving the resin mold; and releasing the center conductive film from the metal substrate for taking out.

Any one of the previous aspects of the presently disclosed embodiment further includes the step of: forming a surface conductive film to cover the center conductive film by second electroplating while using the taken-out center conductive film as a base, thus forming a coil element including the center conductive film and the surface conductive film.

In any one of the first to the third aspects of the presently disclosed embodiment, the resin mold having the inverted coil element pattern engraved in the surface is manufactured by imprinting or hot pressing.

In the first or the second aspects of the presently disclosed embodiment, the resin mold includes thermoplastic resin, and the thermoplastic resin is any one of PMMA, PC and COP.

In the first or the second aspects of the presently disclosed embodiment, the metal seed film includes any one of Cu, Ni, Sn and Al, and the metal seed film is manufactured by any one of vapor deposition, sputtering and a CVD.

In any one of the first to the fourth aspects of the presently disclosed embodiment, the first electroplating is copper plating, and the second electroplating is copper plating.

In the first aspects of the presently disclosed embodiment, the metal seed film is removed in the area where the inverted coil element pattern is not formed by damascene processing or polishing.

In the third aspects of the presently disclosed embodiment, the etching is dry etching, or the etching is wet etching, the resin mold is manufactured in two layers laminated including a first resin on an upper layer side and a second resin on a lower layer side, and the first resin includes PP, and the second resin includes PMMA or PET.

In the third or fourth aspects of the presently disclosed embodiment, the metal substrate includes Ni, SUS or Ni alloy.

In the fourth aspects of the presently disclosed embodiment, the first mold includes Si.

According to the presently disclosed embodiment, a resin mold that is used during the manufacturing of a coil element is removed by dissolving with organic solvent after the formation of the coil element, and so the coil element manufactured can be thin and the coil element can be easily manufactured.

### BRIEF DESCRIPTION OF THE DRAWINGS

FIGS. 1A-1F illustrate steps of manufacturing a coil element according to the first aspect of the presently disclosed embodiment.

FIGS. 2A-2E illustrate steps of manufacturing a coil element according to the second aspect of the presently disclosed embodiment.

FIGS. 3A-3F illustrate steps of manufacturing a coil element according to the third aspect of the presently disclosed embodiment.

FIGS. 4A-4F illustrates steps of manufacturing a coil element according to the fourth aspect of the presently disclosed embodiment.

FIGS. 5A-5G illustrate steps of manufacturing a coil element according to a fifth aspect of the presently disclosed embodiment.

FIG. 6 is a plan view of a coil element assembly manufactured using a consumable mold substrate according to the presently disclosed embodiment.

FIG. 7 illustrates the state of lamination of a plurality of coil element assemblies.

FIGS. 8A-8C describe the laminations of a plurality of coil element assemblies and connecting the coil elements at the respective layers to form a coil.

FIG. 9 illustrates the state where a coil is hermetically sealed using an upper core and a lower core.

FIG. 10 illustrates the state where a coil is internally filled with an insulating substance.

FIGS. 11A-11B illustrate dicing of the laminated coil element assemblies in the units of coils.

FIGS. 12A-12D illustrate the steps of attaching an external electrode at a leading electrode part to form a coil component.

### DETAILED DESCRIPTION

The following describes the presently disclosed embodiment in details, with reference to the attached drawings.

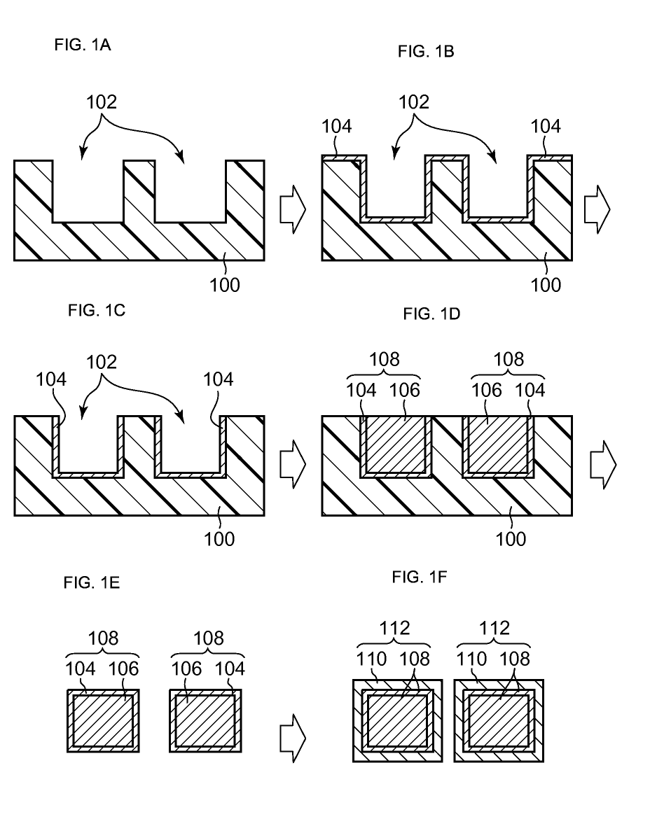

FIGS. 1A-1F illustrate the steps of manufacturing a coil element according to a first aspect of the presently disclosed embodiment.

In the presently disclosed embodiment, a coil element is manufactured using a resin mold that is soluble in organic solvent. A coil element formed in this resin mold is removed after the formation when the resin mold is dissolved. Such a resin mold therefore can be called a consumable mold.

Firstly as illustrated in FIG. 1A, a resin mold 100 is prepared, having a surface on which an inverted coil element pattern 102 is engraved. The resin mold 100 may be made of any material as long as it is soluble in organic solvent, which may be thermoplastic resins, such as PMMA, PC, COP.

The inverted coil element pattern 102 is manufactured on the surface of the resin mold 100 by imprinting or hot pressing.

Next, as illustrated in FIG. 1B, a metal seed film 104 is formed so as to surround the surface of the resin mold 100 in preparation for electroforming (electroplating) performed at a later process. Exemplary metals used for this metal seed film 104 include Cu, Sn, Ni, Ag and Al.

This metal seed film 104 may be formed by electroless plating of copper (Cu), nickel (Ni) or the like or by vapor deposition, sputtering or a CVD.

Next as illustrated in FIG. 1C, a part of the metal seed film 104 on the surface of the resin mold 100 in an area where the inverted coil element pattern 102 is not formed is removed.

This is to prevent electrodeposition during solder plating at a later process in the area where the inverted coil element pattern 102 is not formed.

The removal may be performed by well-known damascene processing or polishing.

Next, as illustrated in FIG. 1D, copper (Cu) is electro-deposited by electroforming (electroplating) while using the remaining metal seed film 104 as a base so as to fill the area where the inverted coil element pattern 102 is engraved, thus forming a center conductive film 106.

The electrodeposition of copper is performed until the area where the inverted coil element pattern 102 is engraved is totally filled, and its surface agrees with the surface of the resin mold 100 to be flat.

Next, as illustrated in FIG. 1E, the resin mold 100 is dissolved with organic solvent, so as to take out a coil element 108 made up of the center conductive film 106 and the metal seed film 104.

The thus taken-out coil element 108 can be transferred to a component substrate (not illustrated) for use or a plurality of coil elements can be laminated for use.

When a high-density coil element is manufactured by narrowing the pattern interval of the thus taken-out coil element 108, as illustrated in FIG. 1F, copper (Cu), for example, may be electro-deposited as a surface conductive film 110 on the surface by electroforming while using the center conductive film 106 and the metal seed film 104 as a base, so as to prepare a coil element 112. This processing may be called plating for thickening.

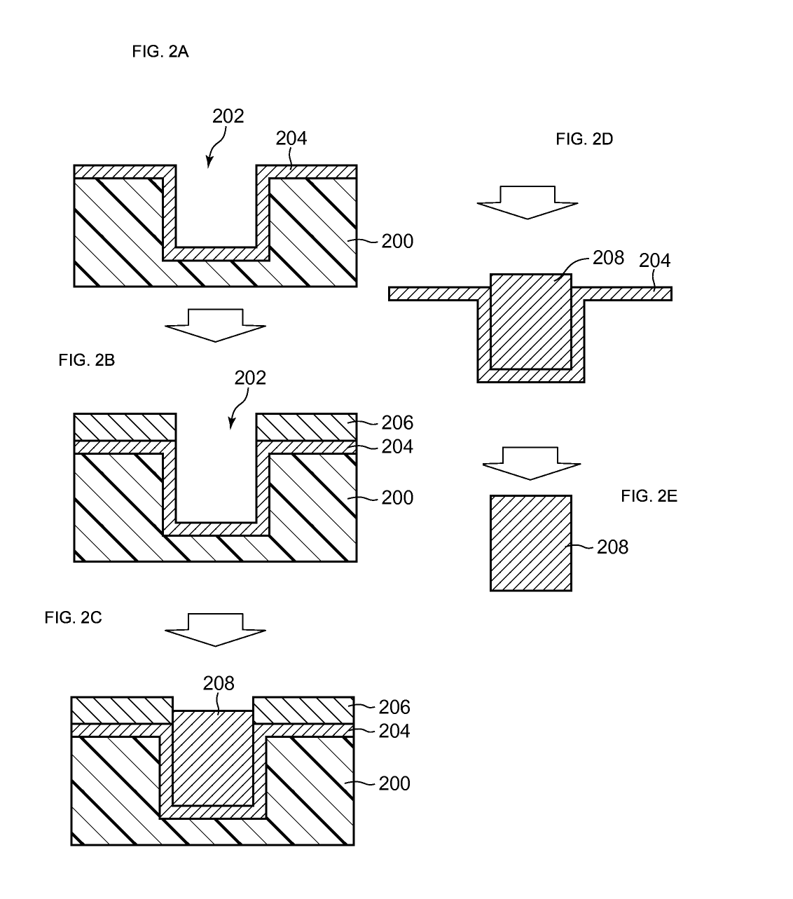

FIGS. 2A-2E illustrate steps of manufacturing a coil element according to a second aspect of the presently disclosed embodiment.

The present aspect has a feature in that the metal seed film is not removed during the process, which is then removed after taking out from the resin mold with the center conductive film.

Firstly as illustrated in FIG. 2A, a resin mold 200 is prepared, having a surface on which an inverted coil element pattern 202 is engraved. Then a metal seed film 204 is formed so as to surround the surface of the resin mold 200. Materials of the resin mold 200, and materials and a method for manufacturing the metal seed film 204 are similar to those of the first aspect of the presently disclosed embodiment.

Next, as illustrated in FIG. 2B, an insulating film 206 is formed using an electrical insulating material in an area where the inverted coil element pattern 202 is not formed.

Next, as illustrated in FIG. 2C, the area where the inverted coil element pattern 202 is engraved is filled by electroplating of copper (Cu) while using the metal seed film 204 as a base, so as to form a center conductive film 208 so as to remain in the insulating film 206.

Then, after removing the insulating film 206 by etching or the like, the resin mold 200 is dissolved with organic solvent similarly to the first aspect of the presently disclosed embodiment, and then as illustrated in FIG. 2D, the center conductive film 208 and the metal seed film 204, which are in a joined state, is taken out.

Finally as illustrated in FIG. 2E, the metal seed film 204 is removed, so as to form a coil element.

The metal seed film 204 may be removed by selective wet etching, for example. Note here that since the metal seed film 204 is very thin, it can be removed without selective wet etching so as not to etch the center conductive film 208 substantially.

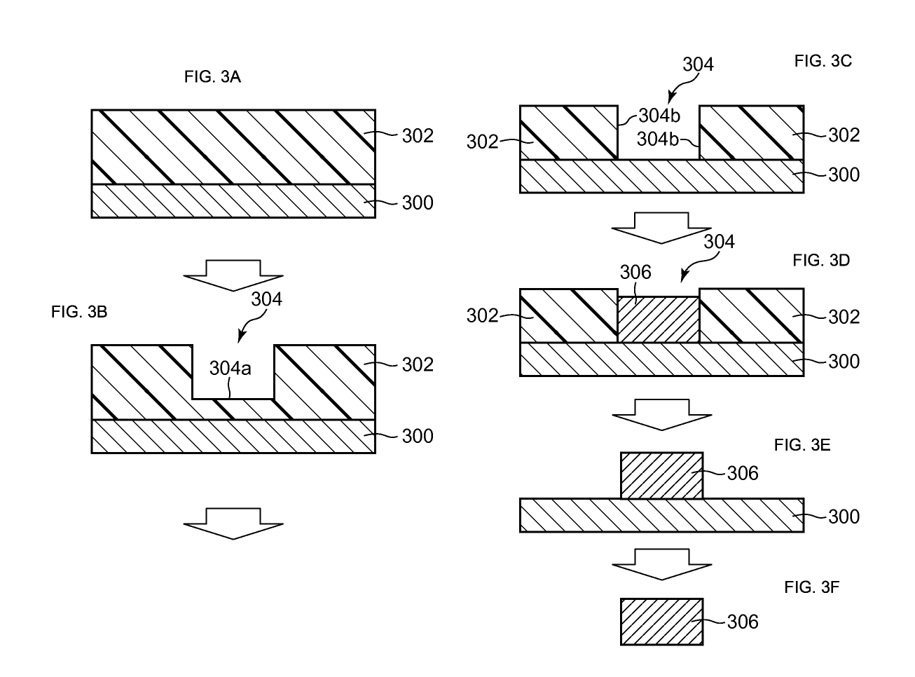

FIGS. 3A-3F illustrate the steps of manufacturing a coil element according to a third aspect of the presently disclosed embodiment.

The present aspect has a feature of not using a metal seed film, and following the formation of a resin mold on a metal substrate, shaping by dry etching.

Firstly as illustrated in FIG. 3A, resin 302 is laminated that is soluble with organic solvent similar to those used in the first and second aspects on a metal substrate 300 made of Ni, SUS, Ni alloy or the like.

Next as illustrated in FIG. 3B, an inverted coil element pattern 304 is engraved by UV imprinting or hot pressing to be at a depth such that a bottom face 304a does not reach the metal substrate 300. Thereby a resin mold is formed.

Next, etching is performed until the bottom face 304a of the inverted coil element pattern 304 reaches the metal substrate 300 so as to remove resin below the bottom face 304a. At this time, dry etching such as RIE may be performed so that the inverted coil element pattern 304 has a side face 304b that is substantially perpendicular to the metal substrate 300 as illustrated in FIG. 3C.

Next as illustrated in FIG. 3D, the area where the inverted coil element pattern 304 is engraved is filled by electroplating of copper (Cu) while using the metal substrate 300 as a base, thus forming a center conductive film 306 so as to remain in the resin mold 302.

Then, similarly to the first and second aspects of the presently disclosed embodiment, the resin mold 302 is dissolved with organic solvent, resulting in that the center conductive film 306 is placed on the metal substrate 300 as illustrated in FIG. 3E.

Finally as illustrated in FIG. 3F, the center conductive film 306 is released from the metal substrate 300, so as to form a coil element.

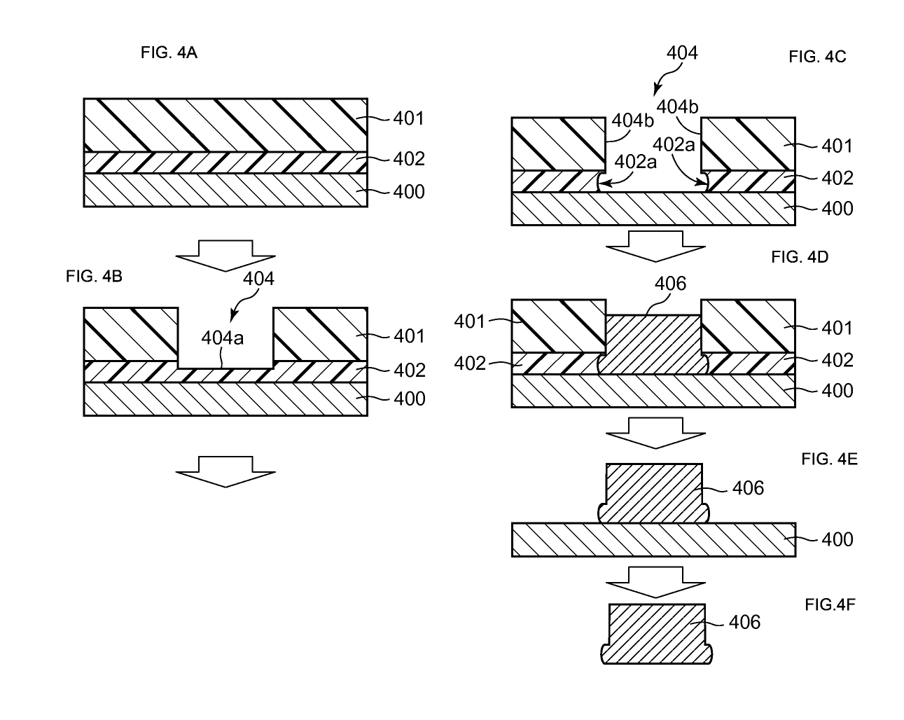

FIGS. 4A-4F illustrates steps of manufacturing a coil element according to a fourth aspect of the presently disclosed embodiment. The present aspect has a feature of not using a metal seed film, and following the formation of a resin mold on a metal substrate, shaping by wet etching.

Firstly as illustrated in FIG. 4A, resins 401 and 402 are laminated to be two layers that are soluble with organic solvent similar to those used in the first and second aspects of the presently disclosed embodiment on a metal substrate 400 made of Ni, SUS, Ni alloy or the like.

The resin 401 at the upper layer is made of PP, and the resin 402 at the lower layer is made of PMMA or PET.

In the case of the present aspect, a double-sided tape with adhesive bond applied to the upper and lower faces is used as the resin 402 at the lower layer.

Next as illustrated in FIG. 4B, an inverted coil element pattern 404 is engraved to be at a depth such that a bottom face 404a reaches the resin 402 at the lower layer internally by UV imprinting or hot pressing. Thereby a resin mold is formed.

Next, etching is performed until the bottom face 404a of the inverted coil element pattern 404 reaches the metal substrate 400 so as to remove resin below the bottom face 404a. At this time, wet etching may be performed so that the resin 402 is etched at a side wall 402a as well, and so the resulting shape is such that the resin 401 overhangs the resin 402 like an eave as illustrated in FIG. 4C.

This is because unlike dry etching, wet etching is isotropic etching. As a result, the side face 404b of the inverted coil element pattern 404 has a shape slightly curved and expanded at a part in contact with the metal substrate 400.

Next as illustrated in FIG. 4D, the area where the inverted coil element pattern 404 is engraved is filled by electroplating of copper (Cu) while using the metal substrate 400 as a base, thus forming a center conductive film 406 so as to remain in the resin mold 401, 402.

Then, similarly to the first through third aspects of the presently disclosed embodiment, the resin mold 401, 402 is dissolved with organic solvent, resulting in that the center conductive film 406 is placed on the metal substrate 400 as illustrated in FIG. 4E.

Finally as illustrated in FIG. 4F, the center conductive film 406 is released from the metal substrate 400, so as to form a coil element.

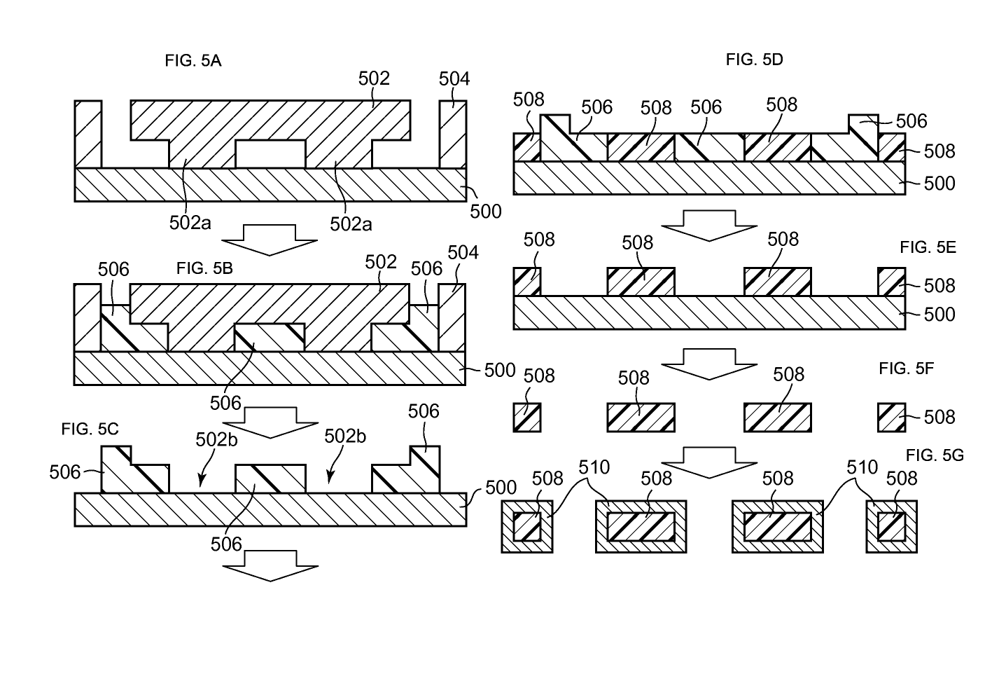

FIGS. 5A-5G illustrate steps of manufacturing a coil element according to a fifth aspect of the presently disclosed embodiment.

The present aspect has a feature of using a method called resin-pouring (casting) dissolution without using a metal seed film, and when forming a resin mold on a metal substrate, placing a mold with a coil element pattern engraved therein on a metal substrate to come into intimate contact therewith, pouring resin into this mold (casting) and curing, followed by removal of this mold to form a resin mold.

Firstly as illustrated in FIG. 5A, a Si mold 502 (first mold) with a coil element pattern 502a engraved therein is placed on a metal substrate 500 made of Ni, SUS, Ni alloy or the like to come into intimate contact therewith. On the metal substrate 500, a member 504 is similarly placed to come into intimate contact therewith, whereby a mold (second mold) is formed.

Next, as illustrated in FIG. 5B, resin 506 that is soluble in organic solvent that is similar to those used in the first through third aspects of the presently disclosed embodiment is poured into the second mold so as to fill the first mold 502, followed by curing. Thermally polymerization resin may be used as the resin 506, whereby it can be easily cured by heating after pouring.

When the first mold 502 is removed, and the member 504 also is removed, then the resin mold 506 is manufactured, on which the inverted coil element pattern 502b is formed as illustrated in FIG. 5C. This is sufficiently cured in this state, followed by the formation of a center conductive film.

As illustrated in FIG. 5D, the area where the inverted coil element pattern 502b is not formed is filled by first electroplating (Cu plating) while using the metal substrate 500 as a base, so as to form a center conductive film 508.

Then, similarly to the first through fourth aspects of the presently disclosed embodiment, the resin mold 506 is dissolved with organic solvent, resulting in that the center conductive film 508 is placed on the metal substrate 500 as illustrated in FIG. 5E.

Next as illustrated in FIG. 5F, the center conductive film 508 is released from the metal substrate 500, so as to form a coil element.

When a high-density coil element is manufactured, as illustrated in FIG. 5G, plating for thickening is performed by second electroplating, so as to electro-deposit a surface conductive film 510 on the surface of the center conductive film 508.

In the above description, one coil element is manufactured considering one resin mold. When a coil element assembly having a plurality of coil elements is collectively manufactured, a resin mold substrate including a plurality of resin molds, each of which has an inverted coil element pattern engraved therein, may be used for manufacturing in a similar manner.

Next, the following describes a method for manufacturing a coil component using the thus manufactured coil element assembly. As described later, a coil component is manufactured by laminating a plurality of coil element assemblies.

Then in order to connect coil elements at the respective layers for bonding, a bonding film has to be formed beforehand around the coil elements.

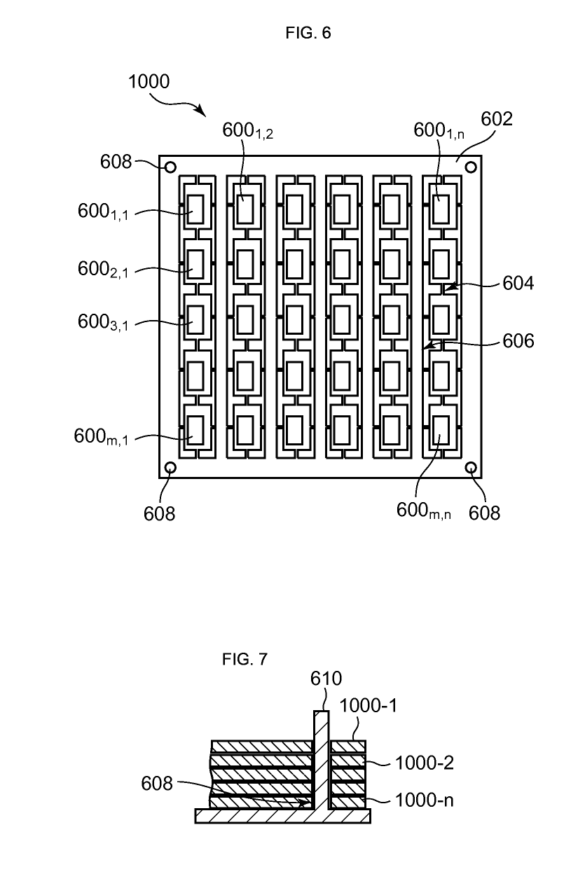

FIG. 6 is a plan view of a coil element assembly 1000 manufactured using a resin mold substrate. A resin mold substrate to manufacture this coil element assembly 1000 also has the same shape. In order to reinforce the conductive pattern of a plurality of coil elements 600m,n (m, n=1, 2, . . . ), a rib 602, a gate 604, and a runner 606 are provided. At four corners of the rib 602, holes 608 are bored, and using a pin 610 penetrating through this hole 608, positioning of conductive patterns of the coil elements 600m,n formed at the respective layers of the plurality of coil element assemblies 1000 is performed.

As illustrated in FIG. 7, a plurality of coil element assemblies 1000-1, 1000-2, . . . 1000-N are laminated via the pin 610 so that their corresponding coil elements in the coil element assemblies are matched, followed by heating and/or pressurizing for bonding, thus connecting the coil elements at the layers to form a coil. The heating and/or pressurizing melts tin plating of the joint film, which acts as soldering to bond the coil elements at the respective layers.

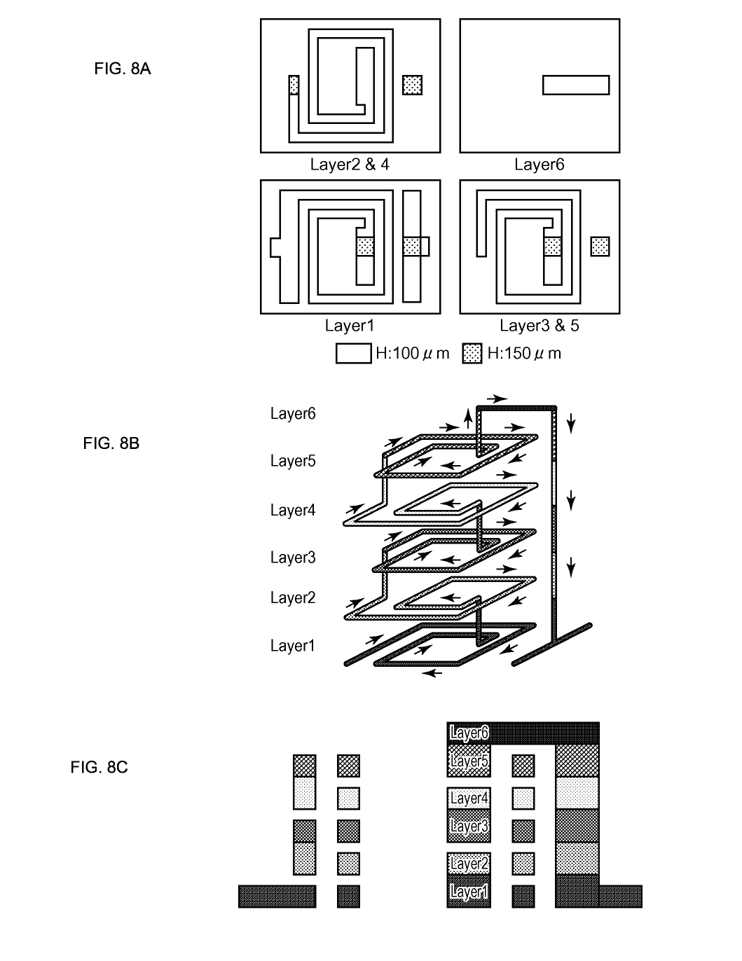

FIGS. 8A-8C describe the lamination of a plurality of coil element assemblies and connecting the coil elements at the respective layers to form a coil. In the embodiment illustrated in FIGS. 8A-8C, six layers of coil element assemblies are laminated, and coil elements at the respective layers are connected so as to form one coil. The corresponding coil elements in the plurality of coil element assemblies may have mutually different coil patterns.

In the example of FIG. 8A, a first layer (Layer 1), a third layer (Layer 3) and a sixth layer (Layer 6) have mutually different coil patterns, and a second layer (Layer 2) and a fourth layer (Layer 4) have the same coil pattern and the third layer (Layer 3) and a fifth layer (Layer 5) have the same coil pattern. FIG. 8B and FIG. 8C illustrate the state of the lamination of these six layers of coil element assemblies, bonding of the corresponding coil elements at the respective layers while being matched and connecting the coil elements to form one coil.

In the manufacturing of a coil element as stated above, they are described so that the center conductive layers making up the coil elements have a uniform height (H). Actually, however, as illustrated in FIG. 8A, they have different heights at the connecting part of each layer. In the example of FIG. 8A, the height (H) at the pattern of a typical coil element is 100 μm, and the height (H) is 150 μm at the connecting part between layers.

When such a coil pattern different in height (H) is manufactured in the same layer, the depth of an engraved pattern formed in the resin mold may be made deeper at the connecting part, for which special copper plating solution for field via may be used, so as to perform charge plating selectively at a deeper part, or perform copper plating using a mask twice.

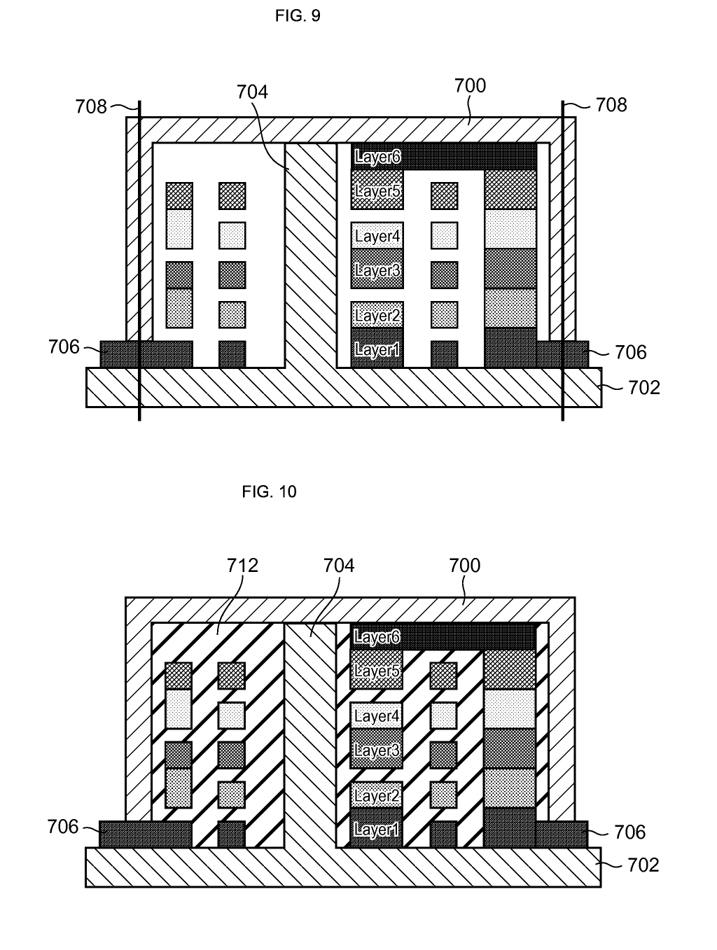

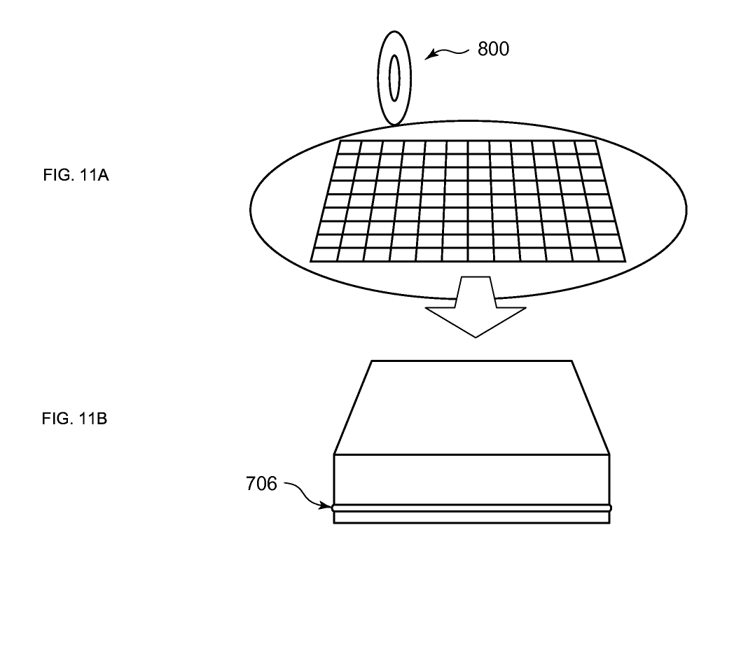

In this way, a coil is formed by connecting the coil elements at the respective layers, then as illustrated in FIG. 9, an upper core 700 and a lower core 702 made of magnetic body, one of which has a protrusion 704 to penetrate through the center part of the coil, are used for hermetically-sealing of the coil while exposing a leading electrode part 706 to the outside. At this time, the upper core 700 and the lower core 702 are attached to circumvent the gate 604 illustrated in FIG. 6 for pattern reinforcement. The upper core 700 and the lower core 702 are cut along a dicing line 708 at the later dicing step. Next, as illustrated in FIG. 10, an insulating substance 712 is poured through a gap (not illustrated) between the upper core 700 and the lower core 702 to fix the coil.

Next, as illustrated in FIGS. 11A-11B, the laminated coil element assemblies are cut in the units of coils using a cutter 800. FIG. 11A illustrates a coil element assembly, and FIG. 11B illustrates one coil component, where the leading electrode part 706 is formed as a part of the first layer (Layer 1).

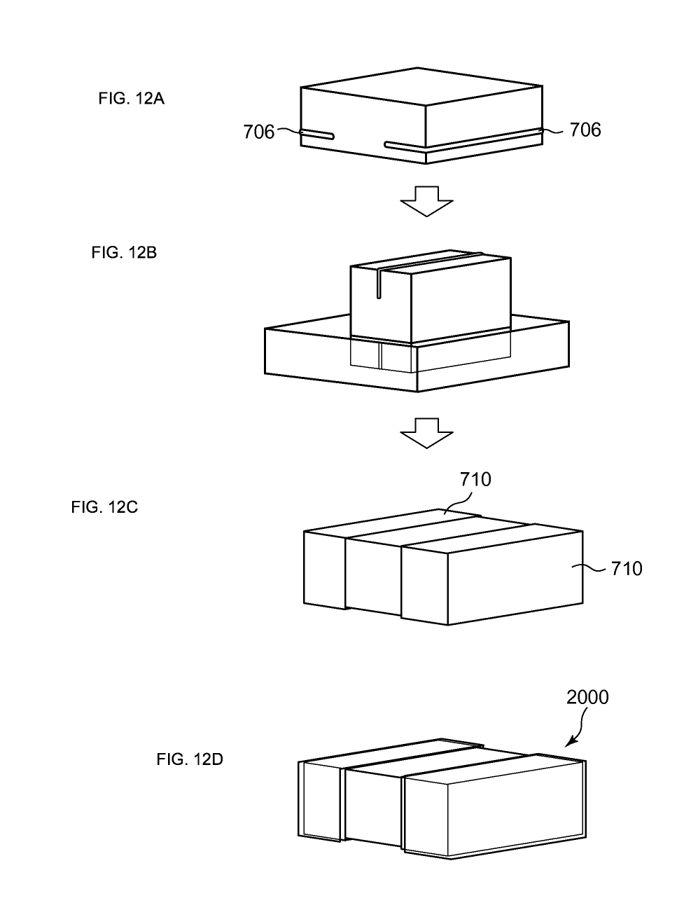

Finally as illustrated in FIGS. 12A-12D, an external electrode 710 is attached to the leading electrode part 706 by dip soldering or the like, to which soldering is performed as pretreatment for subsequent soldering, thus finishing a coil component 2000.

### DESCRIPTION OF REFERENCE NUMERALS

100 resin mold

102 inverted coil element pattern

104 metal seed film

106 center conductive film

108 coil element

110 surface conductive film

200 resin mold

202 inverted coil element pattern

204 metal seed film

206 insulating film

208 center conductive film

300 metal substrate

302 resin that is soluble in organic solvent

304 inverted coil element pattern

306 center conductive film

400 metal substrate

401 resin at upper layer

402 resin at lower layer

404 inverted coil element pattern

406 center conductive film

500 metal substrate

502 Si mold (first mold)

502a coil element pattern

502b inverted coil element pattern

504 member

506 resin that is soluble in organic solvent

508 center conductive film

510 surface conductive film

What is claimed is:

1. A method for manufacturing a coil element using a resin mold that is soluble in organic solvent, comprising:
preparing a resin mold, on a surface of which an inverted coil element pattern is engraved;
forming a metal seed film on the surface of the resin mold;
removing the metal seed film in an area where the inverted coil element pattern is not formed;
forming a center conductive film so as to fill an area where the inverted coil element pattern is engraved by first electroplating while using the metal seed film as a base; and
dissolving the resin mold to take out the center conductive film

2. A method for manufacturing a coil element using a resin mold that is soluble in organic solvent, comprising:
preparing a resin mold, on a surface of which an inverted coil element pattern is engraved;
forming a metal seed film on the surface of the resin mold;
forming an insulating film in an area where the inverted coil element pattern is not formed;
forming a center conductive film that remains in the insulating film so as to fill an area where the inverted coil element pattern is engraved by first electroplating while using the metal seed film as a base;
removing the insulating film;
dissolving the resin mold to take out the center conductive film and the metal seed film; and
removing the metal seed film.

3. A method for manufacturing a coil element using a resin mold that is soluble in organic solvent, comprising:
preparing a resin mold on a metal substrate, the resin mold having an inverted coil element pattern engraved therein so that the inverted coil element pattern has a bottom face that does not reach the metal substrate;
etching so that the bottom face of the inverted coil element pattern reaches the metal substrate so as to remove resin below the bottom face;
forming a center conductive film that remains in the resin mold so as to fill an area where the inverted coil element pattern is engraved by first electroplating while using the metal substrate as a base;
dissolving the resin mold; and
releasing the center conductive film from the metal substrate for taking out.

4. A method for manufacturing a coil element using a resin mold that is soluble in organic solvent, comprising:
preparing a second mold by placing a first mold on a metal substrate, the first mold having an inverted coil element pattern engraved therein so as to come into intimate contact with the metal substrate;
pouring resin in the second mold to fill the first mold with the resin, followed by curing of the resin;
removing the first mold so as to manufacture a resin mold, in which an inverted coil element pattern is formed;
forming a center conductive film so as to fill an area where the inverted coil element pattern is engraved by first electroplating while using the metal substrate as a base;
dissolving the resin mold; and
releasing the center conductive film from the metal substrate for taking out.

5. The method according to claim 1, further comprising the step of: forming a surface conductive film to cover the center conductive film by second electroplating while using the taken-out center conductive film as a base, thus forming a coil element including the center conductive film and the surface conductive film.

6. The method according to claim 1, wherein the resin mold having the inverted coil element pattern engraved in the surface is manufactured by imprinting or hot pressing.

7. The method according to claim 1, wherein the resin mold comprises thermoplastic resin.

8. The method according to claim 7, wherein the thermoplastic resin is any one of PMMA, PC and COP.

9. The method according to claim 1, wherein the metal seed film includes any one of Cu, Ni, Sn and Al.

10. The method according to claim 1, wherein the metal seed film is manufactured by any one of vapor deposition, sputtering and a CVD.

11. The method according to claim 1, wherein the first electroplating is copper plating.

12. The method according to claim 5, wherein the second electroplating is copper plating.

13. The method according to claim 1, wherein the metal seed film is removed in the area where the inverted coil element pattern is not formed by damascene processing or polishing.

14. The method according to claim 3, wherein the etching is dry etching.

15. The method according to claim 3, wherein the etching is wet etching.

16. The method according to claim 3, wherein the resin mold is manufactured in two layers laminated including a first resin on an upper layer side and a second resin on a lower layer side.

17. The method according to claim 16, wherein the first resin comprises PP, and the second resin comprises PMMA or PET.

18. The method according to claim 3, wherein the metal substrate comprises Ni, SUS or Ni alloy.

19. The method according to claim 4, wherein the first mold comprises Si.
